(19) United States
(12) Patent Application Publication
(10) Pub. No.: US 2025/0036355 A1
(43) Pub. Date: Jan. 30, 2025

(54) AUDIO CONTROL METHOD, WEARABLE DEVICE, AND ELECTRONIC DEVICE

(71) Applicant: GOERTEK INC., Weifang (CN)

(72) Inventors: Long JIANG, Weifang (CN); Zongxia ZHU, Weifang (CN); Kang AN, Weifang (CN); Jie WU, Weifang (CN)

(21) Appl. No.: 18/912,644

(22) Filed: Oct. 11, 2024

Related U.S. Application Data
(63) Continuation of application No. PCT/CN2023/105729, filed on Jul. 4, 2023.

(30) Foreign Application Priority Data
Aug. 10, 2022 (CN) 202210953134.X

(51) Int. Cl. G06F 3/16

(52) U.S. Cl. CPC G06F 3/165

(57) ABSTRACT

An audio control method, a wearable device, and an electronic device. The audio control method is used for controlling the wearable device. The audio control method includes: providing an acoustic waveguide structure configured to implement a sound focusing function; acquiring an operation status of the acoustic waveguide structure, and generating a first control signal when the operation status of the acoustic waveguide structure is in an enabled state; and reducing a sound volume of the loudspeaker of the wearable device according to the first control signal.

The present disclosure claims a priority to a Chinese patent application No. 202210953134.X, entitled “audio control method, wearable device, and electronic device”, filed with China Patent Office on Aug. 10, 2022, which is incorporated by reference into the present disclosure in its entirety.

### TECHNICAL FIELD

The present disclosure relates to a wearable device, and more specifically, to an audio control method, a wearable device and an electronic device.

### BACKGROUND

With the increased frequency of using wearable devices, users will use the wearable devices to make phone calls, listen to music or watch videos. However, a phenomenon of voice leakage of the wearable device will lead to the leakage of the privacy of the user.

If a sound volume of smart glasses is set to be low, the impact on the neighbor is relatively small, but it is not easy to be identified when making a voice call and listening to a song through the smart glasses. However, in a noisy environment, the user needs to adjust the sound volume of call of the smart glasses to the maximum to hear the audio. In this way, the content of the call or the audio is also easily to be identified by the outside, which leads to a technical problem of poor privacy of the smart glasses.

### SUMMARY

An object of the present disclosure is to provide a new technical solution of an audio control method, a wearable device, and an electronic device.

In one aspect of the present disclosure, an audio control method for controlling a wearable device is provided, wherein the audio control method comprises:
providing an acoustic waveguide structure configured to implement a sound focusing function;
acquiring an operation status of the acoustic waveguide structure, and generating a first control signal when the operation status of the acoustic waveguide structure is in an enabled state; and
reducing a sound volume of a loudspeaker of the wearable device according to the first control signal.

Optionally, before the acquiring the operation status of the acoustic waveguide structure, the audio control method further includes:
acquiring an ambient noise, and generating a first prompt signal when the ambient noise is greater than or equal to a set threshold, wherein the first prompt signal is configured to prompt a user whether to enable the acoustic waveguide structure.

Optionally, the operation status of the acoustic waveguide is acquired after a preset time—since the first prompt signal is generated.

Optionally, the acquiring the ambient noise includes:
acquiring an ambient sound;
acquiring a voice;
calculating a difference between the ambient sound and the voice, wherein the difference is the ambient noise.

Optionally, the wearable device includes a microphone configured to acquire the ambient sound and a bone conduction audio sensing device configured to acquire the voice,
wherein before the acquiring the ambient noise, the audio control method further includes acquiring an operating mode of the wearable device, and generating a second prompt signal when the operating mode is a music mode,
wherein the second prompt signal is configured to prompt the user whether to enable the microphone and the bone conduction audio sensing device.

Optionally, before the acquiring the operation status of the acoustic waveguide structure, the audio control method further includes:
acquiring an operating mode of the wearable device, acquiring the operation status of the acoustic waveguide structure when the operating mode is a call mode, and generating a second control signal when the operation status of the acoustic waveguide structure is in the enabled state,
wherein the second control signal is configured to adjust a frequency of the loudspeaker to a set range.

Optionally, the set range is 300 Hz to 4 KHz.

Optionally, the threshold is 85 dB.

In another aspect of the present disclosure, a wearable device is provided, which includes:
an acoustic waveguide structure configured to implement a sound focusing function;
a detection module configured to detect an operation status of the acoustic waveguide structure and transmit the detected operation status to outside;
an audio adjustment module configured to adjust a sound volume of a loudspeaker; and
a processor configured to acquire the operation status of the acoustic waveguide structure, wherein the processor generates a first control signal and sends the first control signal to outside when the acoustic waveguide structure is in an enabled state, and
wherein the audio adjustment module acquires the first control signal and reduces the sound volume of the loudspeaker of the wearable device.

Another aspect of the present disclosure provides an electronic device including a memory configured to store computer programs and a processor configured to execute the computer programs to implement the above audio control method.

Another aspect of the present disclosure provides a computer readable storage medium on which computer programs are stored, wherein when the computer programs are executed by a processor, the above audio control method is implemented.

In this way, when the sound volume of the smart glasses is high and the acoustic waveguide structure is in the enabled state, the acoustic waveguide structure may form a physical barrier between the sound hole and the outside, to achieve an effect of avoiding sound leakage. At the same time, under the blocking of the acoustic waveguide structure, the sound can be gathered in the direction toward the user, so that the loudness of the sound heard by the user will be greater, which ensures the user's use experience.

### BRIEF DESCRIPTION OF DRAWINGS

In order to explain the technical solution in the embodiments of the present disclosure or the related art, the drawings required to be used in the description of the embodiments or the related art will be briefly introduced below. Obviously, the drawings described below are only part of the drawings in the present disclosure. For those skilled in the art, other drawings may also be obtained according to the drawings provided without creative work.

FIG. 1 is a first flowchart of the audio control method of the wearable device in some embodiments of the present disclosure;

FIG. 2 is a second flowchart of the audio control method of the wearable device in some embodiments of the present disclosure;

FIG. 3 is a third flowchart of the audio control method of the wearable device in some embodiments of the present disclosure;

FIG. 4 is a fourth flowchart of the audio control method of the wearable device in some embodiments of the present disclosure;

FIG. 5 is a fifth flowchart of the audio control method of the wearable device in some embodiments of the present disclosure;

FIG. 6 is a schematic diagram of the electronic device in some embodiments of the present disclosure;

FIG. 7 is a structural diagram of the wearable device in some embodiments of the present disclosure; and

FIG. 8 is a response frequency effect diagram of the audio control method of the wearable device in some embodiments of the present disclosure.

### REFERENCE NUMBERS

400, electronic device; 401, processor; 402, memory; 403, baffle.

### DETAILED DESCRIPTIONS

Technical solutions in some embodiments of the present disclosure will be described below in combination with the drawings in the embodiments of the present disclosure. Obviously, the described embodiments are only a part of the embodiments of the present disclosure, but not all embodiments. Based on the embodiments in the present disclosure, all other embodiments obtained by those skilled in the art without creative work are within the protection scope of the present disclosure.

### <Control Method>

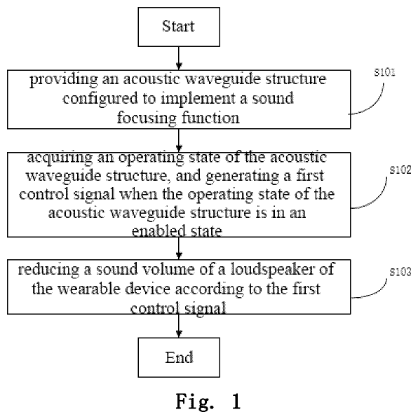

In some embodiments of the present disclosure, an audio control method is provided, for controlling a wearable device. In the audio control method, the subject of performing the method is a processor. FIG. 1 is a flowchart of the audio control method of the wearable device of the embodiment of the present disclosure.

As shown in FIG. 1, the control method includes:
S101, providing an acoustic waveguide structure configured to implement a sound focusing function;
S102, acquiring an operation status of the acoustic waveguide structure, and generating a first control signal when the operation status of the acoustic waveguide structure is in an enabled state; and
S103, reducing a sound volume of a loudspeaker of the wearable device according to the first control signal.

For example, the wearable device is smart glasses, etc., with an audio function. Moreover, the acoustic waveguide structure is a structure that can implement the function of sound focusing. As shown in FIG. 1, the processor of the wearable device acquires the operation status of the acoustic waveguide structure. When the operation status of the acoustic waveguide structure acquired by the processor is an enabled state, the first control signal is generated to reduce the sound volume of the loudspeaker. When the operation status of the acoustic waveguide structure acquired by the processor is disabled, the sound volume of the loudspeaker is not changed.

For example, when the user wears the smart glasses, the processor acquires the acoustic waveguide structure being in the enabled state, and the processor generates the first control signal. Based on the first control signal, the processor reduces the sound volume of the loudspeaker to a set volume.

For example, the loudness of the sound is 40 dB before the acoustic waveguide structure is enabled, and the loudness of the sound of the loudspeaker is reduced to 30 dB after the processor detects the acoustic waveguide structure being enabled. In this way, the acoustic waveguide structure itself has a sound focusing function, thereby preventing sound leakage, and at the same time, the sound volume of the loudspeaker is reduced, which can have a better effect of preventing sound leakage. In addition, the acoustic waveguide structure is avoided from being enabled, and the loudness of the sound received by the user becomes higher after the sound is focused, thus affecting the user's hearing.

In this way, when the acoustic waveguide structure is in the enabled state, the sound propagating around from a sound hole can be gathered in the direction toward the user under the block of the acoustic waveguide structure. In this way, when the sound output frequency is the same, the user hears a louder sound. Therefore, even if the processor reduces the loudness of the loudspeaker of the wearable device, it will not cause the hearing impairment of the user. In this way, the user's use experience is ensured while improving the privacy of the wearable device.

In one embodiment of the present disclosure, before the acquiring the operation status of the acoustic waveguide structure, the audio control method further includes:
S200, acquiring an ambient noise, and generating a first prompt signal when the ambient noise is greater than or equal to a set threshold, wherein the first prompt signal is configured to prompt a user whether to enable the acoustic waveguide structure.

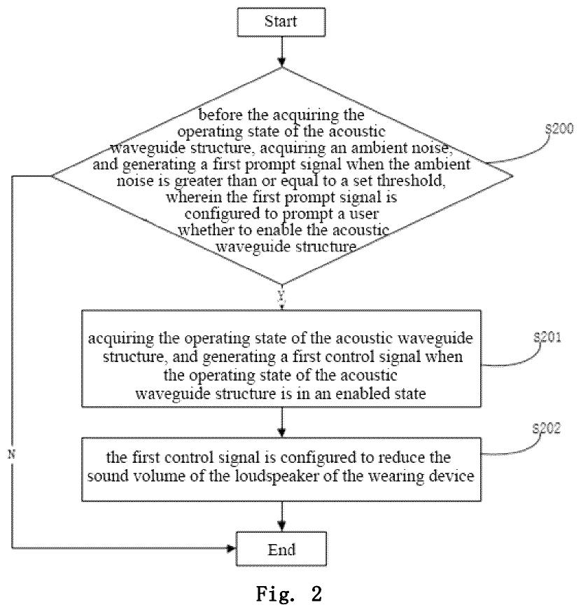

As shown in FIG. 2, the processor acquires the ambient noise, and when the acquired ambient noise is greater than or equal to the set threshold, the processor determines that the current environment is a high noise environment. The high noise environment refers to a noise environment when the ambient noise is greater than or equal to the set threshold. When the acquired ambient noise is greater than or equal to the set threshold, the processor sends the first prompt signal. When the processor receives a feedback of the first prompt signal of “Yes”, step S201 is performed in which the processor acquires the operation status of the acoustic waveguide structure, and when the operation status of the acoustic waveguide structure acquired by the processor is in the enabled state, the first control signal is generated. Then a step S202 is performed, in which the sound of the loudspeaker is reduced. When the processor receives the feedback of the first prompt signal of “No”, the audio control is terminated.

For example, before the processor acquires the operation status of the acoustic waveguide structure, the processor acquires the ambient noise, and when the ambient noise falls into a set threshold or a threshold scope, or is the same as the set threshold, the processor sends the first prompt signal to the user. The first prompt signal may be a voice signal or a vibration signal, as long as it can prompt the user. After the processor acquires the feedback of “Yes”, the processor acquires the operation status of the acoustic waveguide structure. When the processor acquires the acoustic waveguide structure being in the enabled state, the processor reduces the sound of the loudspeaker.

The processor may identify the ambient noise to determine the noise environment of the current user. When the ambient noise meets the set threshold, the processor identifies the high noise environment, and actively prompts the user to choose whether to enable the acoustic waveguide structure. The user is prompted to enable the acoustic waveguide structure in the high noise environment, to achieve the sound focusing function, and at the same time to reduce the sound volume of the loudspeaker in the high noise environment. Thus, it is ensured that the user can clearly receive the sound from the loudspeaker in the high noise environment, and at the same time, it is ensured that the user's privacy is prevented from being leaked.

In one embodiment of the present disclosure, the operation status of the acoustic waveguide is acquired after a pre-set time since the first prompt signal is generated.

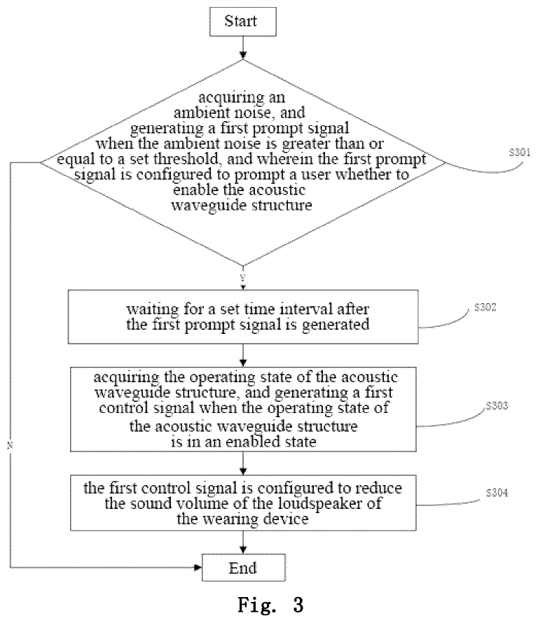

As shown in FIG. 3, the processor is set to acquire the operation status of the acoustic waveguide after a pre-set time since the first prompt signal is generated. For example, 2 seconds after the first prompt signal is generated, the processor begins acquiring the operation status of the acoustic waveguide.

In one embodiment of the present disclosure, the acquiring the ambient noise includes:
acquiring an ambient sound;
acquiring a voice;
calculating a difference between the ambient sound and the voice, and wherein the difference is the ambient noise.

For example, the processor acquires the ambient sound and the voice, and calculates the difference between the loudness of the ambient sound and the loudness of the voice to acquire the ambient noise. Besides, the processer compares the ambient noise with the set threshold.

In this way, the ambient noise can be accurately acquired, so as to determine the high noise environment.

In one example, the set threshold is 85 dB.

For example, when the loudness of the ambient sound is 100 dB, and the loudness of the voice is 10 dB, the ambient noise is 90 dB. If the ambient noise is greater than 85 dB, the processor determines that the current environment is the high noise environment. As shown in FIGS. 2 and 3, when the ambient noise is greater than or equal to 85 dB, the current environment is the high noise environment. After identifying as the high noise environment, the processor acquires the acoustic waveguide structure being enabled, and the processor reduces the sound of the loudspeaker to a set volume. Alternatively, after identifying as the high noise environment, the processor generates the first prompt signal, and when the user's feedback of “Yes” is received, the processor acquires the operation status of the acoustic waveguide structure, the processor acquires the acoustic waveguide structure being enabled, and the processor reduces the sound of the loudspeaker to the set volume.

In this way, based on the acoustic waveguide structure, and combined with the determination function of the ambient noise, the user can be prompted to remind the user to enable the acoustic waveguide structure according to the noise environment, and the loudness of the audio is automatically adjusted according to the state of whether the acoustic waveguide is enabled, so as to avoid the sound from being greater after the acoustic waveguide structure is enabled, which affects the user's hearing experience.

In one example of the present disclosure, the wearable device includes a microphone configured to acquire the ambient sound and a bone conduction audio sensing device configured to acquire the voice,
wherein before the acquiring the ambient noise, the audio control method further includes:
acquiring an operating mode of the wearable device, and generating a second prompt signal when the operating mode is a music mode,
wherein the second prompt signal is configured to prompt the user whether to enable the microphone and the bone conduction audio sensing device.

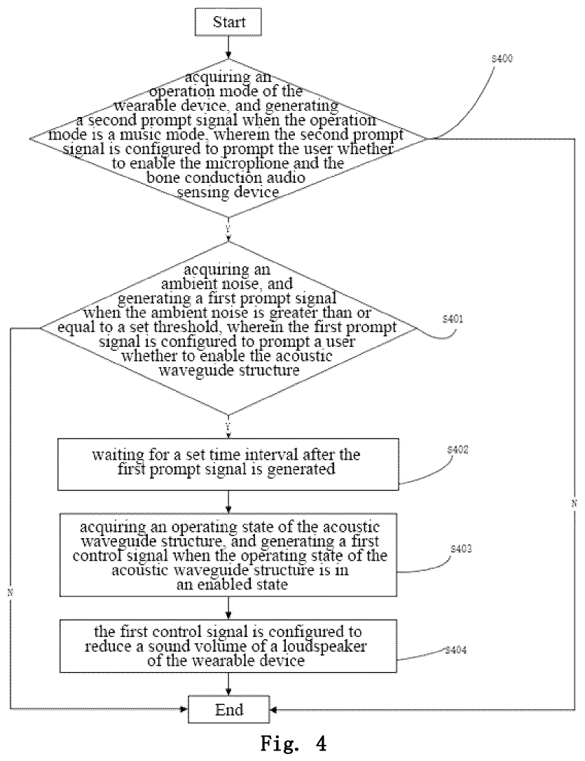

As shown in FIG. 4, the processor acquires the operating mode of the wearable device. The wearable device has a call mode and a music mode. The music mode includes a music playing mode and a video playing mode. When the processor acquires the operating mode being the music mode, the second prompt signal is generated and sent to outside, to prompt the user to enable the microphone and the bone conduction audio sensing device, so as to acquire the ambient noise.

For example, when the processor detects the smart glasses being in the music mode, the processor sends the second prompt signal. When the processor receives the feedback of the second prompt signal of “Yes”, step 401 is performed, in which the ambient noise is acquired, and when the ambient noise is greater than or equal to the set threshold, the processor generates the first prompt signal. After the first prompt signal is generated by the processor, step 402 is performed, in which the operation status of the acoustic waveguide structure is acquired after a pre-set time since the first prompt signal is generated. When the acoustic waveguide structure is in the enabled state, the first control signal is generated, and the sound volume of the loudspeaker is reduced according to the first control signal.

In this way, the use state of the user can be determined, to prompt whether to enable the acoustic waveguide structure according to the user's needs.

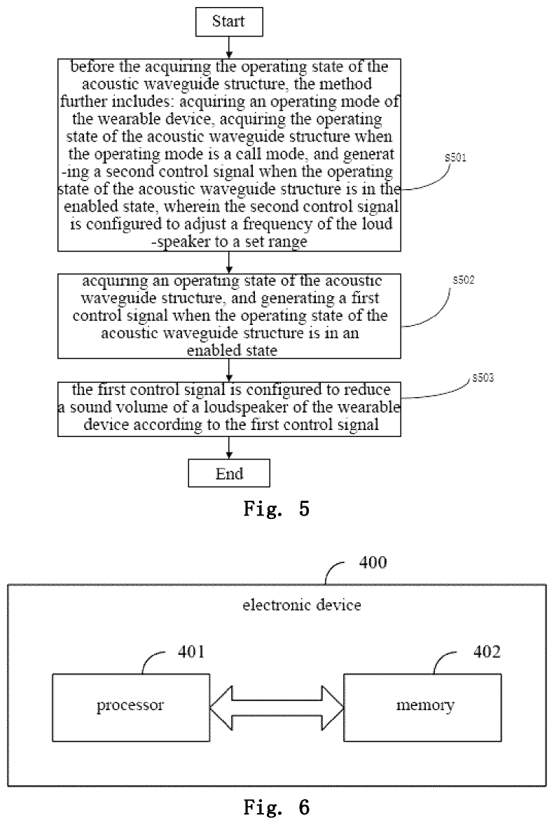

In one embodiment, as shown in FIG. 5, before the acquiring the operation status of the acoustic waveguide structure, the audio control method further includes: acquiring an operating mode of the wearable device, acquiring the operation status of the acoustic waveguide structure when the operating mode is a call mode, and generating a second control signal when the operation status of the acoustic waveguide structure is in the enabled state, wherein the second control signal is configured to adjust a frequency of the loudspeaker to a set range.

For example, as shown in FIG. 5, the processor acquires the operating mode of the wearable device. When the wearable device is in the call mode, the processor acquires whether the acoustic waveguide structure is in the enabled state, and when the acoustic waveguide structure is in the enabled state, the processor generates the second control signal and sends it to outside, to adjust the frequency of the loudspeaker to the set range.

For example, when the smart glasses are used to answer or make a phone call, and the processor identifies that the smart glasses are in the call mode, the processor acquires the operation status of the acoustic waveguide structure and reduces the sound volume of the loudspeaker when the acoustic waveguide structure is in the enabled state. At the same time, the processor generates the second control signal to adjust the frequency of the loudspeaker to the set range.

Here, the order of generating the first control signal and generating the second control signal is not limited, and the order of adjusting the frequency of the loudspeaker by the processer and adjusting the sound volume of the loudspeaker by the processer is not limited, and those skilled in the art can choose according to their needs.

In this way, when the user is in the call mode, the acoustic waveguide structure can further protect the privacy of the call of the user.

For example, the set range is 300 Hz-4 KHz.

For example, under a normal condition, the frequency of the loudspeaker is below 8 kHz. When the processor acquires the acoustic waveguide structure being in the enabled state, the frequency band below 8 kHz is concentrated to 300 Hz-4 KHz.

Thus, the audio of the call is clearer.

In one example, while adjusting the frequency of the loudspeaker to 300 Hz-4 KHz, the sound volume is turned down to a set intensity.

In this way, the privacy of the user can be further improved, to prevent the occurrence of the leakage of the loudspeaker.

FIG. 8 is illustrated, which is a response frequency effect diagram of the audio control method of the wearable device in the embodiment of the present disclosure. In FIG. 8, the horizontal coordinate is the frequency of the voice signal sensed by the bone conduction audio sensing device, and the vertical coordinate is the loudness of the sound which can be felt by the user under the frequency of the voice signal. L2 is the response frequency curve after the acoustic waveguide structure is enabled. L1 is the response frequency curve after the acoustic waveguide structure is disabled. Under the same frequency of the voice signal, the loudness of the sound felt by the user when the acoustic waveguide structure is enabled is obviously higher than that when the acoustic waveguide structure is disabled.

Therefore, according to the audio control method in the present disclosure, the loudness of the sound felt by the user become higher, and therefore, the loudness of the sound felt by the user is not affected when the loudness of the loudspeaker sound is reduced. In this way, the privacy of the user can be ensured under the premise of ensuring that user can receive good voice signals.

### <Wearable Device>

In one embodiment of the present disclosure, a wearable device is provided which includes:
an acoustic waveguide structure configured to implement a sound focusing function;
a detection module configured to detect an operation status of the acoustic waveguide structure and transmit the detected operation status to outside;
an audio adjustment module configured to adjust a sound volume of a loudspeaker; and
a processor configured to acquire the operation status of the acoustic waveguide structure, wherein the processor generates a first control signal and sends the first control signal to outside when the acoustic waveguide structure is in an enabled state,
wherein the audio adjustment module acquires the first control signal and reduces the sound volume of the loudspeaker of the wearable device.

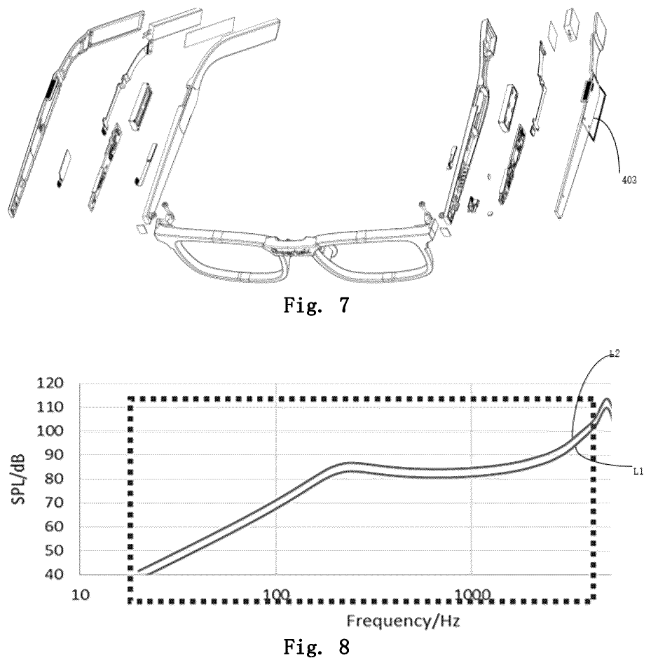

As shown in FIG. 7, the smart glasses have a housing on which a sound hole(s) is disposed. In the housing, an audio assembly is disposed at a position corresponding to the sound hole, and the audio assembly has a loudspeaker. The sound emitted by the loudspeaker can be transmitted to outside by the sound hole and received by the user. The acoustic waveguide structure is located on the housing at a side of the sound hole away from the user.

For example, the acoustic waveguide structure is a movable baffle 403, which may be a straight plate or may have a curve or arc. When the acoustic waveguide structure is enabled, the baffle 403 is extended to outside from the housing, to prevent the sound wave of the sound hole from diffusing to outside and changing the propagation direction of the sound wave from the sound hole. When the acoustic waveguide structure is disabled, the baffle 403 extends into the housing and is accommodated in the housing.

For example, the detection module is a Hall sensor, and a magnetic element matching with the Hall sensor is disposed on the baffle 403 of the acoustic waveguide structure. When the Hall sensor is in the operation status, and the baffle 403 with a magnetic element is extended out of the housing, the magnetic element is close to the Hall sensor and is induced with the Hall sensor. The operation status of the acoustic waveguide structure is determined according to whether the Hall sensor is induced with the magnetic element. After the processor detects the acoustic waveguide structure being enabled, the processor generates the first control signal. The audio adjustment module can acquire the first control signal, and the audio adjustment module reduces the sound volume of the loudspeaker. The audio adjustment module is a module that can adjust the sound volume of the loudspeaker, and those skilled in the field can choose the audio adjustment module by themselves.

In this way, when the acoustic waveguide structure is in the enabled state, the acoustic waveguide structure can form a physical barrier between the sound hole and the outside, thus has an effect of avoiding sound leakage. At the same time, under the obstruction of the acoustic waveguide structure, the sound propagating around from the sound hole can be gathered in the direction toward the user. In this way, when the sound output frequency is the same, the user hears the sound with a higher loudness. In this way, the user's experience is ensured while improving the privacy of the wearable device.

In one embodiment of the present disclosure, the wearable device further includes a prompt module. The prompt module is configured to receive the first prompt signal and make the corresponding prompt, to remind the user to select whether to enable the acoustic waveguide structure. When the user selects to enable the acoustic waveguide structure, the processor receives the feedback of “Yes”, the processor acquires the acoustic waveguide structure being enabled, and the processor reduces the sound of the loudspeaker to the set volume.

In one example, the wearable device includes a microphone configured to acquire the ambient sound and a bone conduction audio sensing device configured to acquire the voice.

The microphone is configured to collect the ambient sound. The bone conduction audio sensing device is configured to acquire a downlink voice signal. The downlink voice signal is the voice signal received by the bone conduction audio sensing device, which is different from the ambient sound.

In one example, the prompt module can also receive a second prompt signal. When the processor identifies that the wearable device is in the music mode, the processor generates the second prompt signal. The processor acquires the operating modes of the microphone and the bone conduction audio sensor to determine the operating mode of the wearable device. When the microphone is in the enabled state and the bone conduction audio sensing device is also in the enabled state, the wearable device is in a call mode. When the microphone is in a disabled state and the bone-conduction audio sensor is in the enabled state, the wearable is in a music mode. The second prompt signal is configured to prompt the user whether to enable the microphone and the bone conduction audio sensing device to acquire the ambient noise.

### <Electronic Device>

In another embodiment of the present disclosure, an electronic device 400 is also provided. As shown in FIG. 6, the electronic device includes:
a memory 402 configured to store executable computer instructions; and
a processor 401 configured to perform the above detection method according to the control of the executable computer instructions.

### <Computer Readable Storage Medium>

According to another embodiment of the present disclosure, a computer readable storage medium is provided on which computer instructions are stored, wherein when the computer programs are executed by a processor, the above audio control method of a first aspect.

The computer readable storage medium may be a tangible device that may hold and store instructions used by an instruction execution device. For example, the computer readable storage medium may be an electrical storage device, a magnetic storage device, an optical storage device, an electromagnetic storage device, a semiconductor storage device or any suitable combination of the above, but is not limited thereto. More specific examples of the computer readable storage medium (a non-exhaustive list) include: a portable computer disk, a hard disk, a random access memory (RAM), a read-only memory (ROM), an erasable programmable read-only memory (EPROM or a flash memory), a static random access memory (step RAM), a portable compact disk Read-only memory (CD-ROM), a digital multifunction disk (DVD), a memory stick, a floppy disk, a mechanical coding device (for example, a punch card on which instructions are stored or a convex structure in a groove), and any suitable combination of the above. The computer readable storage medium used here are not interpreted as instantaneous signals themselves, such as radio waves or other freely propagating electromagnetic waves, electromagnetic waves propagating through waveguides or other transmission medium (for example, light pulses through fiber optic cables), or electrical signals transmitted by wires.

The computer readable program instructions described herein may be downloaded from the computer readable storage medium to individual computing/processing devices, or to an external computer or an external storage device by a network (for example, an Internet, a local area network, a wide area network, and/or a wireless network). The network may include a copper transmission cable, a fiber optic transmission, a wireless transmission, a router, a firewall, a switch, a gateway computer and/or an edge server. The network adapter card or the network interface in each computing/processing device receives the computer readable program instructions from the network and forwards the computer readable program instructions for storage in the computer readable storage medium in the individual computing/processing devices.

The computer program instructions used to perform the operation of the present disclosure may be assembly instructions, instruction set architecture (I step A) instructions, machine instructions, machine related instructions, microcode, firmware instructions, state setting data, or source or object code written in any combination of one or more programming languages. The programming languages include object-oriented programming languages, such as Step malltalk, C++, etc. and regular procedural programming languages, such as the “C” language or similar programming languages. The computer-readable program instructions may be executed entirely on the user's computer, executed partly on the user's computer, executed as an independent soft package, executed partly on the user's computer and partly on a remote computer, or executed entirely on the remote computer or the server. In the case of related to the remote computer, the remote computer may be connected to the user computer by any kind of network, including a local area network (LAN) or a wide area network (WAN), or it may be connected to an external computer (for example, using an Internet service provider to connect by the Internet). In some embodiments, an electronic circuit, such as a programmable logic circuit, field programmable gate array (FPGA) or programmable logic array (PLA), may be personalized customized by using the state information of the computer readable program instructions, and the electronic circuit can execute the computer readable program instructions to achieve various aspects of the present disclosure.

Various aspects of the present disclosure are described herein with reference to flowchart and/or block diagrams of methods, devices (systems) and computer program products according to embodiments of the present disclosure. It should be understood that each box of the flowchart and/or the combination of the boxes in the flowchart and/or the block diagram can be implemented by the computer-readable program instructions.

These computer-readable program instructions may be provided to the processor of a general-purpose computer, a special-purpose computer, or other programmable data processing device, thereby producing a machine, such that these instructions, when executed by the processor of the computer or other programmable data processing device, generate a device which implement a function/action specified in one or more boxes in the flowchart and/or the block diagram. These computer readable program instructions may also be stored in the computer readable storage medium, these instructions make the computer, the programmable data processing device and/or other device to operate in a particular manner, so that the computer readable medium that stores the instructions includes a manufactured product which includes instructions for implementing various aspects of the functions/actions specified in one or more boxes in the flowchart and/or block diagram.

The computer readable program instructions may also be loaded on a computer, other programmable data processing device, or other device, such that a series of operating steps are performed on the computer, other programmable data processing device, or other device, to produce a computer-implemented process. Thus, the instructions executed on the computer, other programmable data processing device, or other device implement the functions/actions specified in one or more boxes in the flowchart and/or the block diagram.

The flowcharts and the block diagrams in the attached drawings show the architecture, functions and operations which can be implemented by the system, the method and the computer program product according to a plurality of embodiments of the present disclosure. In this regard, each box in the flowchart or the block diagram may represent a module, a program segment, or a part of an instruction that contains one or more executable instructions for implementing a specified logical function. In some alternative implementations, the functions indicated in the box can also occur in an order different from those indicated in the drawing. For example, two consecutive boxes can actually be executed basically in parallel, and they can sometimes be executed in reverse order, depending on the functionality involved. It should be noted that, each box in the block diagram and/or the flowchart and the combination of the boxes in the block diagram and/or the flowchart may be implemented by a dedicated hardware-based system that performs a specified function or action, or by a combination of dedicated hardware and computer instructions. It is well known for those skilled in the art that implementation by hardware, implementation by software, and implementation by a combination of software and hardware are all equivalent.

Embodiments of the present disclosure have been described above and are illustrative, not exhaustive and are not limited to the embodiments disclosed. Without deviating from the scope and spirit of the embodiments illustrated, many modifications and changes are apparent for those skilled in the art. The terms used herein have been chosen to best explain the principle, practical application, or technical improvement in the market of each embodiment, or to make those skilled in the art understand the embodiments disclosed herein. The scope of the present disclosure is limited by the attached claims.

What is claimed is:

1. An audio control method for controlling a wearable device, wherein the wearable device comprises an acoustic waveguide structure configured to implement a sound focusing function, and wherein the audio control method comprises:
acquiring an operation status of the acoustic waveguide structure, and generating a first control signal when the operation status of the acoustic waveguide structure is in an enabled state; and
reducing a sound volume of a loudspeaker of the wearable device according to the first control signal.

2. The audio control method of claim 1, wherein before the acquiring the operation status of the acoustic waveguide structure, the audio control method further comprises:
acquiring an ambient noise, and generating a first prompt signal when the ambient noise is greater than or equal to a set threshold, wherein the first prompt signal is configured to prompt a user whether to enable the acoustic waveguide structure.

3. The audio control method of claim 2, wherein the first prompt signal is configured to actively prompt the user to choose whether to enable the acoustic waveguide structure.

4. The audio control method of claim 2, wherein the operation status of the acoustic waveguide is acquired after a pre-set time since the first prompt signal is generated.

5. The audio control method of claim 2, wherein the acquiring the ambient noise comprises:
acquiring an ambient sound;
acquiring a voice; and
calculating a difference between the ambient sound and the voice, wherein the difference is the ambient noise.

6. The audio control method of claim 5, wherein the wearable device comprises a microphone configured to acquire the ambient sound and a bone conduction audio sensing device configured to acquire the voice,
wherein before the acquiring the ambient noise, the audio control method further comprises acquiring an operating mode of the wearable device, and generating a second prompt signal when the operating mode is a music mode,
wherein the second prompt signal is configured to prompt the user whether to enable the microphone and the bone conduction audio sensing device.

7. The audio control method of claim 1, wherein before the acquiring the operation status of the acoustic waveguide structure, the audio control method further comprises:
acquiring an operating mode of the wearable device, acquiring the operation status of the acoustic waveguide structure when the operating mode is a call mode, and generating a second control signal when the operation status of the acoustic waveguide structure is in the enabled state,
wherein the second control signal is configured to adjust a frequency of the loudspeaker to a set range.

8. The audio control method of claim 7, wherein the set range is 300 Hz to 4 KHz.

9. The audio control method of claim 2, wherein the set threshold is 85 dB.

10. The audio control method of claim 1, wherein when the acoustic waveguide structure is in the enabled state, the acoustic waveguide structure forms a physical barrier between the sound hole and exterior, and sound propagating around from a sound hole is gathered in a direction toward a user of the wearable device by physical barrier of the acoustic waveguide structure.

11. The audio control method of claim 2, wherein when the acoustic waveguide structure is in the enabled state, the acoustic waveguide structure changes the propagation direction of the sound wave from the sound hole.

12. A wearable device comprising:
an acoustic waveguide structure configured to implement a sound focusing function;
a detection module configured to detect an operation status of the acoustic waveguide structure and transmitting the detected operation status to outside;
an audio adjustment module configured to adjust a sound volume of a loudspeaker; and
a processor configured to acquire the operation status of the acoustic waveguide structure, wherein the processor generates a first control signal and sends the first control signal to outside when the acoustic waveguide structure is in an enabled state, and
wherein the audio adjustment module acquires the first control signal and reduces the sound volume of the loudspeaker of the wearable device.

13. The wearable device of claim 12, wherein the wearable device is glasses.

14. The wearable device of claim 13, wherein the acoustic waveguide structure is located on a housing of the wearable device at a side of the sound hole away from a user of the wearable device.

15. The wearable device of claim 13, wherein the acoustic waveguide structure comprises a movable baffle which is straight or curved.

16. The wearable device of claim 13, wherein the baffle is stretched out from the housing when the acoustic waveguide structure is enabled, and is retracted into and accommodated in the housing when the acoustic waveguide structure is disabled.

17. The wearable device of claim 12, wherein the detection module comprises a Hall sensor, and a magnetic element matching with the Hall sensor is disposed on the baffle of the acoustic waveguide structure.

18. The wearable device of claim 13, wherein when the acoustic waveguide structure is in the enabled state, the acoustic waveguide structure forms a physical barrier between the sound hole and exterior, and sound propagating around from a sound hole is gathered in a direction toward a user of the wearable device by physical barrier of the acoustic waveguide structure.

19. The wearable device of claim 13, wherein when the acoustic waveguide structure is in the enabled state, the acoustic waveguide structure changes the propagation direction of the sound wave from the sound hole.

20. An electronic device comprising a memory configured to store computer programs and a processor configured to execute the computer programs to implement the audio control method of claim 1.
